(19) United States
(12) Patent Application Publication
(10) Pub. No.: US 2026/0038918 A1
(43) Pub. Date: Feb. 5, 2026

(54) Apparatus for Molding Secondary Battery Pouch and Secondary Battery Pouch Manufactured Thereby

(71) Applicant: LG Energy Solution, Ltd., Seoul (KR)

(72) Inventors: Shin Chul Kim, Daejeon (KR); Seung Yop Lee, Daejeon (KR); Chung Hee Lee, Daejeon (KR); Sun II Lee, Daejeon (KR)

(73) Assignee: LG Energy Solution, Ltd., Seoul (KR)

(21) Appl. No.: 19/101,050

(22) PCT Filed: Aug. 16, 2023
(86) PCT No.: PCT/KR2023/012124

§ 371 Date: Feb. 4, 2025

(30) Foreign Application Priority Data
Aug. 31, 2022 (KR) 10-2022-0110313

(51) Int. Cl. H01M 50/105; H01M 10/04

(52) U.S. Cl. CPC H01M 50/105; H01M 10/0404

(57) ABSTRACT

The present invention relates to an apparatus for molding a secondary battery pouch and a secondary battery pouch manufactured therethrough, and more particularly, to an apparatus for molding a secondary battery pouch, which allows a pouch bridge part to be unfolded well when the pouch is folded so as to prevent cell damage, improve cell positioning precision, and prevent wrinkles on a cell sealing part, thereby producing a secondary battery having excellent quality, and a secondary battery pouch manufactured therethrough.

### CROSS-REFERENCE TO RELATED APPLICATIONS

The present application is a 371 National Stage entry of PCT/KR2023/012124 filed on Aug. 16, 2023, and which claims the benefit of foreign priority to Korean Patent Application No. 10-2022-0110313, filed in the Republic of Korea on Aug. 31, 2022, the disclosures of which are hereby incorporated by reference in their entirety.

### TECHNICAL FIELD

The present disclosure relates to an apparatus for molding a secondary battery pouch and a secondary battery pouch manufactured therethrough, and more particularly, to an apparatus for molding a secondary battery pouch, which allows a pouch bridge part to be unfolded well when the pouch is folded so as to prevent cell damage, improve cell positioning precision, and prevent wrinkles on a cell sealing part, thereby producing a secondary battery having excellent quality, and a secondary battery pouch manufactured therethrough.

### BACKGROUND

In recent years, the price of energy sources increases due to the depletion of fossil fuels, the interest in environmental pollution is amplified, and the demand for eco-friendly alternative energy sources is becoming an indispensable factor for future life. Accordingly, studies on various power generation technologies such as solar power, wind power, and tidal power are continuing, and power storage devices such as batteries for more efficiently using the generated electrical energy are also of great interest.

Furthermore, as technology development and demand for electronic mobile devices and electric vehicles using batteries increase, the demands for batteries as energy sources are rapidly increasing. Thus, many studies on batteries which are capable of meeting various demands have been conducted.

In particular, in terms of materials, there is a high demand for lithium secondary batteries such as lithium ion batteries and lithium ion polymer batteries having advantages such as high energy density, discharge voltage, and output stability.

The secondary batteries are classified into cylindrical batteries and prismatic batteries, in which an electrode assembly is embedded in a cylindrical or prismatic metal can, and pouch-type batteries, in which an electrode assembly is embedded in a pouch-type case made of an aluminum laminate sheet according to shapes of battery cases.

FIG. 1 is a cross-sectional view of a pouch-type secondary battery according to a related art. In detail, FIG. 1 is a cross-sectional view illustrating a pouch of a secondary battery and an electrode assembly, which is embedded in the pouch.

A pouch-type secondary battery 1 includes an electrode assembly 20, in which electrodes and separators are alternately stacked, and a pouch 10, into which the electrode assembly is inserted. In addition, the pouch includes cup parts 11 and 12 of the pouch, each of which has a recessed shape so that the electrode assembly is directly accommodated. The cup parts of the pouch may be provided with a left cup part 11 and a right cup part 12 to surround the electrode assembly at both sides thereof.

A portion connecting the left cup part 11 to the right cup part 12 may be a pouch bridge part 13. The left cup part 11 may be folded to an upper portion of the right cup part 12 with respect to the pouch bridge part 13. In this folding process, the cup parts 11 and 12 of the pouch may form an accommodation space, and the electrode assembly 20 may be accommodated in the accommodation space.

Referring to FIG. 1, in the related art, there is a problem in that the pouch bridge part 13 is not unfolded well when the left cup part 11 is folded to the upper portion of the right cup part 12. As a secondary battery become increasingly larger in capacity, a depth of pouch molding increases, and a resulting pouch thickness increases. As a result, when folding the pouch after molding, there is a problem in which the pouch bridge part 13 is not unfolded well as illustrated in FIG. 1. As described above, if the pouch bridge part 13 is not unfolded well and thus has a shape that protrudes toward the electrode assembly 20, the cell damage in which the pouch bridge part 13 damages the electrode assembly 20 may occur. In addition, if the pouch bridge part 13 is not unfolded well, an outer appearance of the cell may not be formed precisely, and thus, a position may not be accurately measured by a vision camera or the like. This could cause a decrease in location accuracy. In addition, if the pouch bridge part 13 is not unfolded well, a problem of wrinkles occurring when sealing the periphery of the pouch may occur due to the decrease in precision. Therefore, there is a high need to ensure that the pouch bridge part 13 is unfolded well when folding the pouch.

### SUMMARY

### Technical Problem

The present disclosure is invented to solve the above problem, and an object of the present disclosure is to provide an apparatus for molding a secondary battery pouch, which allows a pouch bridge part to be unfolded well when the pouch is folded so as to prevent cell damage, improve cell positioning precision, and prevent wrinkles on a cell sealing part, thereby producing a secondary battery having excellent quality, and a secondary battery pouch manufactured therethrough.

### Technical Solution

An apparatus for molding a secondary battery pouch according to the present disclosure includes a die in which an accommodation groove for molding a cup part of a pouch on a base surface, on which the pouch is placed, is defined, and a punch inserted into the accommodation groove of the die to mold the cup part of the pouch, wherein the die includes a left accommodation groove having a recessed shape, a right accommodation groove defined in a side portion of the left accommodation groove and having a recessed shape, and a bridge part configured to connect the left accommodation groove to the right accommodation groove between the left accommodation groove and the right accommodation groove, wherein the bridge part has a recessed shape so that a height of a central portion thereof is less than that of each of both ends in a longitudinal direction.

The bridge part may have a height that continuously decreases from each of both the ends to the central portion.

A cross-section of the bridge part, which is cut by a virtual vertical plane that divides the left and right accommodation grooves while passing through the bridge part may have a shape similar to a portion or entire of a U-shape.

A cross-section of the bridge part, which is cut by a virtual vertical plane that divides the left and right accommodation grooves while passing through the bridge part may have a shape similar to a portion or entire of a circular or oval shape.

The central portion of the bridge part may have a height of 9 mm to 10 mm, and each of both the ends of the bridge part has a height of 11 mm to 12 mm.

The punch may include a punch protrusion having a shape protruding to correspond to the recessed shape of the bridge part.

An apparatus for molding a secondary battery pouch according to the present disclosure includes a die in which an accommodation groove for molding a cup part of a pouch on a base surface, on which the pouch is placed, is defined, and a punch inserted into the accommodation groove of the die to mold the cup part of the pouch, wherein the die includes a left accommodation groove having a recessed shape, a right accommodation groove defined in a side portion of the left accommodation groove and having a recessed shape, and a bridge part configured to connect the left accommodation groove to the right accommodation groove between the left accommodation groove and the right accommodation groove, wherein each of the left accommodation groove and the right accommodation groove has a horizontal bottom surface on a central area and an inclined bottom surface on each of both end areas, based on a direction parallel to a longitudinal direction of the bridge part.

In both the ends areas, the bottom surface of each of the left accommodation groove and the right accommodation groove may be inclined so that a height thereof increases as approaching the bridge part.

An inclination angle formed by the bottom surfaces of the left accommodation groove and the right accommodation groove with respect to a horizontal plane may be 1 degree to 10 degrees.

Each of the left accommodation groove and the right accommodation groove may include a bottom surface and a sidewall surface extending upward from a circumference of the bottom surface, and the sidewall surface of the left accommodation groove, which is measured based on the bottom surface of the left accommodation groove, may have the same height at the central area and both the end areas.

The sidewall surface of the right accommodation groove, which is measured based on the bottom surface of the right accommodation groove, may have the same height at the central area and both the end areas

The left accommodation groove and the right accommodation groove may be defined in shapes that are symmetrical to each other with respect to the bridge part. An apparatus for molding a secondary battery pouch according to the present disclosure includes a die in which an accommodation groove for molding a cup part of a pouch on a base surface, on which the pouch is placed, is defined, and a punch inserted into the accommodation groove of the die to mold the cup part of the pouch, wherein the die includes a left accommodation groove having a recessed shape, a right accommodation groove defined in a side portion of the left accommodation groove and having a recessed shape, and a bridge part configured to connect the left accommodation groove to the right accommodation groove between the left accommodation groove and the right accommodation groove, wherein the bridge part has a recessed shape so that a height of a central portion is less than that of each of both ends in a longitudinal direction, and each of the left accommodation groove and the right accommodation groove has a horizontal bottom surface on a central area and an inclined bottom surface on each of both end areas, based on a direction parallel to a longitudinal direction of the bridge part.

A secondary battery pouch according to the present disclosure includes a pouch cup part comprising two cup parts such as a left cup part and a right cup part, and a pouch bridge part configured to connect the two cup parts to each other between the left cup part to the right cup part, wherein the pouch bridge part may have a recessed shape so that a height of the central portion is less than that of each of both the ends in a longitudinal direction.

The central portion of the pouch bridge part may have a height of 2 mm to 4 mm, and each of both the ends of the pouch bridge part has a height of 4 mm to 6 mm.

A secondary battery pouch according to the present disclosure may include a pouch cup part comprising two cup parts such as a left cup part and a right cup part, and a pouch bridge part configured to connect the two cup parts to each other between the left cup part to the right cup part, wherein each of the left cup part and the right cup part has a horizontal bottom surface on a central area and an inclined bottom surface on each of both end areas, based on a direction parallel to a longitudinal direction of the bridge part.

A secondary battery pouch may include a pouch cup part comprising two cup parts such as a left cup part and a right cup part, and a pouch bridge part configured to connect the two cup parts to each other between the left cup part to the right cup part, wherein the pouch bridge part has a recessed shape so that a height of the central portion is less than that of each of both the ends in a longitudinal direction, and each of the left cup part and the right cup part has a horizontal bottom surface on a central area and an inclined bottom surface on each of both end areas, based on a direction parallel to a longitudinal direction of the bridge part.

### ADVANTAGEOUS EFFECTS

In the apparatus for molding the secondary battery pouch and the secondary battery pouch manufactured therethrough, when the pouch is folded, the pouch bridge part may be unfolded well to prevent the cell damage, improve the cell positioning precision, and prevent the wrinkles on the cell sealing part, thereby producing the secondary battery having the excellent quality.

### BRIEF DESCRIPTION OF THE DRAWINGS

FIG. 1 is a cross-sectional view of a pouch-type secondary battery according to a related art.

FIG. 2 is a perspective view illustrating a die of an apparatus for molding a secondary battery pouch according to Aspect 1 of the present disclosure.

FIG. 3 is a cross-sectional view of a bridge part, taken along line C-C′ of FIG. 2.

FIG. 4 shows perspective and cross-sectional views of a punch of the apparatus for manufacturing the secondary battery pouch according to Aspect 1 of the present disclosure. FIG. 4 part (a) is a perspective view illustrating a punch of the apparatus for manufacturing the secondary battery pouch according to Aspect 1 of the present disclosure. And FIG. 4 part (b) is a cross-sectional view illustrating the punch illustrated in FIG. 4 part (a).

FIG. 5 is a perspective view illustrating a secondary battery pouch manufactured by the apparatus for molding the secondary battery pouch according to Aspect 1 of the present disclosure.

FIG. 6 is a perspective view illustrating a die of an apparatus for molding a secondary battery pouch according to Aspect 2 of the present disclosure.

FIG. 7 is a cross-sectional view taken at a position S1 of FIG. 6.

FIG. 8 is a cross-sectional view taken at positions S2 and S3 of FIG. 6.

FIG. 9 is a perspective view illustrating the secondary battery pouch manufactured by the apparatus for molding the secondary battery pouch according to Aspect 2 of the present disclosure.

FIG. 10 is a cross-sectional view taken at a position P1 of FIG. 9.

FIG. 11 is a cross-sectional view taken at positions P2 and P3 of FIG. 9.

FIG. 12 is a perspective view illustrating a die of an apparatus for molding a secondary battery pouch according to Aspect 3 of the present disclosure.

### DETAILED DESCRIPTION

Reference characters used in the present disclosure a
100, 200, 300: Apparatus for molding secondary battery pouch
110, 210, 310: Die
111, 211, 311: Left accommodation groove
211-1: Bottom surface of left accommodation groove
211-2: Sidewall surface
112, 212, 312: Right accommodation groove
212-1: Bottom surface of right accommodation groove
113, 213, 313: Base surface
214, 314: Central area
215, 315: Both end areas
120, 220, 320: Bridge part
121, 321: Central portion
122, 322: Both ends
130, 230: Secondary battery pouch
131, 231: Left cup part
231-1: Bottom surface of left cup part
231-2: Sidewall surface
232-1: Bottom surface of right cup part
132, 232: Right cup part
133, 233: Pouch cup part
234: Central area of pouch
235: Both end areas of pouch
140, 240: Pouch bridge part
141: Central portion
142: Both ends
150: Punch
151: Punch protrusion

Hereinafter, preferred aspects of the present disclosure will be described in detail with reference to the accompanying drawings so that those of ordinary skill in the art may easily carry out the present disclosure. However, the present disclosure may be implemented in several different forms and is not limited or restricted by the following examples.

In order to clearly explain the present disclosure, detailed descriptions of portions that are irrelevant to the description or related known technologies that may unnecessarily obscure the gist of the present disclosure have been omitted, and in the present specification, reference symbols are added to components in each drawing. In this case, the same or similar reference numerals are assigned to the same or similar elements throughout the specification.

Also, terms or words used in this specification and claims should not be restrictively interpreted as ordinary meanings or dictionary-based meanings, but should be interpreted as meanings and concepts conforming to the scope of the present disclosure on the basis of the principle that an inventor may properly define the concept of a term to describe and explain his or her disclosure in the best ways.

### Aspect 1

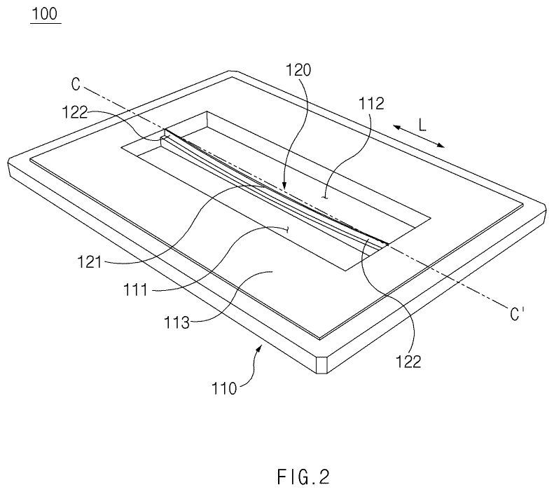

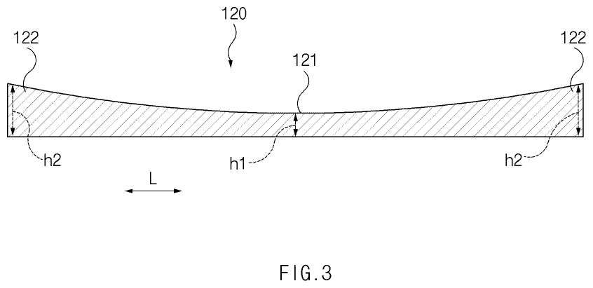

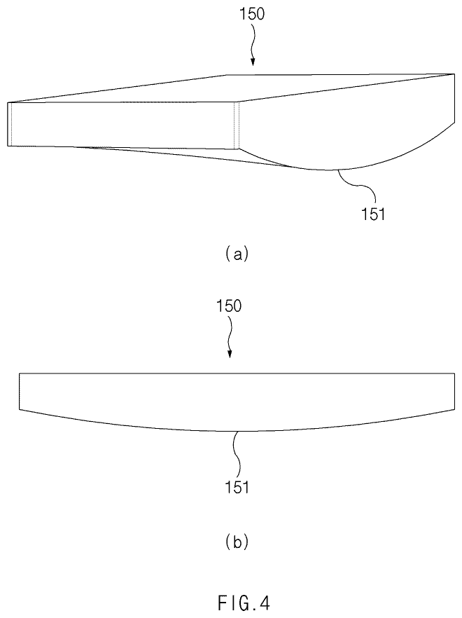

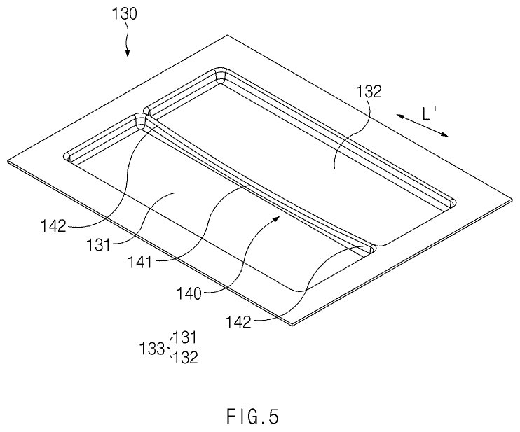

FIG. 2 is a perspective view illustrating a die of an apparatus for molding a secondary battery pouch according to Aspect 1 of the present disclosure. FIG. 3 is a cross-sectional view of a bridge part, taken along line C-C′ of FIG. 2. FIG. 4 part (a) is a perspective view illustrating a punch of the apparatus for manufacturing the secondary battery pouch according to Aspect 1 of the present disclosure. FIG. 4 part (b) is a cross-sectional view illustrating the punch illustrated in FIG. 4 part (a). FIG. 5 is a perspective view illustrating a secondary battery pouch manufactured by the apparatus for molding the secondary battery pouch according to Aspect 1 of the present disclosure.

Referring to FIGS. 2 to 5, an apparatus 100 for molding a secondary battery pouch according to Aspect 1 of the present disclosure may include a die 110 and a punch 150.

The die 110 may be configured to have an accommodation groove for molding a cup part 133 of the pouch on a base surface 113 on which the pouch is placed.

Specifically, the die 110 includes a left accommodation groove 111 having a recessed shape, a right accommodation groove 112 formed next to the left accommodation groove 111 and having an recessed shape, and a bridge part 120 connecting the left accommodation groove 111 to the right accommodation grooves 112 between the left accommodation groove 111 and the right accommodation groove 112.

The punch 150 may be configured to mold the cup part of the pouch while being inserted into the accommodation groove of the die 110. A pouch base material having a flat shape may be placed on the base surface 113, and then, the punch 150 may descend to mold the pouch. The punch 150 may mold the pouch with a shape corresponding to a shape of the die 110. The pouch may be molded while the punch 150 is inserted into the groove having the recessed shape of the die 110. The pouch molded in this manner may have the same shape as the secondary battery pouch 130, which is illustrated in FIG. 5.

In the apparatus 100 for molding the secondary battery pouch according to Aspect 1 of the present disclosure, the bridge part 120 may have a recessed shape so that a height of a central portion 121 of the bridge part 120 is less than that of each of both ends 122 in a longitudinal direction L. Referring to FIGS. 2 and 3, a height of the bridge part 120 may continuously decrease from both the ends 122 to the central portion 121.

Referring to FIG. 3, in the bridge part 120, a cross-section cut by a virtual vertical plane that divides the left and right accommodation grooves while passing through the bridge part 120 may have a shape similar to a portion or entire of a U-shape. When cut in the virtual vertical plane, the cross-sectional shape of the bridge part 120 as illustrated in FIG. 3 may appear. As illustrated in FIG. 3, the cross-section of the bridge part 120, which is taken along the line C-C′, may a curved shape, and in particular, the cross-section may be provided as a portion or entire of the U-shape.

In addition, in the bridge part 120, a cross-section cut by a virtual vertical plane that divides the left and right accommodation grooves while passing through the bridge part 120 may have a shape similar to a portion or entire of a circular or oval shape.

Referring to FIG. 3, a height h1 of the central portion 121 of the bridge part 120 may be 9 mm to 10 mm, and a height h2 of each of both the ends 122 of the bridge part 120 may be 11 mm to 12 mm. Thus, the bridge part 120 may have a shape in which each of both the ends 122 is higher, and the height decreases toward the central portion 121.

Referring to FIG. 4 part (a), the punch 150 may include a punch protrusion 151 having a shape protruding to correspond to the recessed shape of the bridge part 120. The punch protrusion 151 may be a portion disposed at a position corresponding to the bridge part 120 of the die 110. The pouch base material may be disposed between the punch protrusion 151 and the bridge part 120 of the die 110 and then be pressed. Thus, the pouch bridge part 140 may be molded in a shape corresponding to the shape of the bridge part 120 of the die 110. If the portion of the punch 150 corresponding to the bridge part 120 has a flat shape rather than the protruding shape, a space of the central portion 121 may be insufficient compared to both the ends 122 of the bridge part 120. Thus, when the punch 150 is provided in the protruding shape such as the U shape, a height difference may be compensated.

FIG. 4 part (b) illustrates a cross-section of the punch protrusion 151 illustrated in FIG. 4. The cross-section of the punch protrusion 151 may have a shape corresponding to the cross-section of the bridge part 120 of the die 110. That is, the cross-sectional shape of the punch protrusion 151 may be formed in the same shape as a portion or entire of the U-shape and may be formed in the same shape as a portion or entire of the circular or oval shape.

When the pouch is molded using the apparatus 100 for molding the secondary battery pouch described above, the secondary battery pouch 130 illustrated in FIG. 5 may be manufactured.

Referring to FIG. 5, the secondary battery pouch 130 manufactured by the apparatus 100 for manufacturing the secondary battery pouch according to Aspect 1 of the present disclosure may include a pouch cup part 133 and a pouch bridge part 140.

Here, the pouch cup part 133 may include two cup parts such as a left cup part 131 and a right cup part 132. The pouch cup part 133 may be configured to be provided with two cup parts such as a left cup part 131 and a right cup part 132. The pouch bridge part 140 may be configured to connect the two cup parts to each other between the left cup part 131 and the right cup part 132.

A portion molded by a left accommodation groove 111 of the die 110 may be the left cup part 131, and a portion molded by the right accommodation groove 112 may be the right cup part 132. In addition, the portion formed by the bridge part 120 of the die 110 may be the pouch bridge part 140.

Thus, in the secondary battery pouch 130 manufactured by the apparatus 100 for molding the secondary battery pouch according to Aspect 1 of the present disclosure, the pouch bridge part 140 may be formed in a recessed shape so that a height of the central portion 141 is less than a height of each of both the ends 142 in a longitudinal direction L′.

Specifically, the height of the central portion 141 of the pouch bridge part may be 2 mm to 4 mm, and the height of each of both the ends 142 of the pouch bridge part may be 4 mm to 6 mm. Thus, the pouch bridge part may have a shape in which each of both the ends 142 is higher, and the height decreases toward the central portion 141.

In the pouch bridge part 140, when the central portion 141 is formed in the recessed shape so that the height is less than the height of each of both the ends 142, the pouch bridge part 140 may be easily unfolded when the pouch is folded.

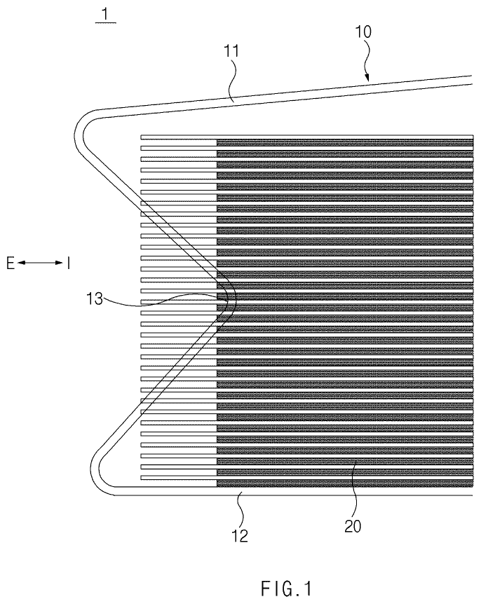

Referring to FIG. 1, according to the related art, the pouch bridge part 140 is not unfolded well. That is, as illustrated in FIG. 1, the pouch bridge part 140 has a shape that protrudes in an inner direction I of the secondary battery, as if a V shape is turned at an angle of 90 degrees in a counterclockwise direction. In this case, as illustrated in FIG. 1, an interference between the internal electrode assembly and the pouch bridge part 140 may occur, and thus, damage of the electrode assembly may occur. In particular, there is a problem in that the central portion 141 of the pouch bridge part 140 is not unfolded well. Each of both the ends 142 of the pouch bridge part 140 may be formed with an outer corner, and thus, both the ends 142 may be unfolded well due to stronger tension applied during the folding. On the other hand, the central portion 141 may not be unfolded well due to weak tension.

However, in the secondary battery pouch 130 manufactured by the apparatus 100 for molding the secondary battery pouch according to the present disclosure, a width of the pouch bridge part 140 is formed to be relatively shorter at the central portion 141 of the pouch bridge part 140. That is, each of both the ends 142 of the pouch bridge part 140 formed by a high-height portion of the bridge part 120 of the die 110 may be formed to have a long width and length, and the central portion 141 of the pouch bridge part 140 molded by a low-height portion of the bridge part 120 of the die 110 may be formed to have a shorter width. Thus, the central portion 141 of the pouch bridge part 140 may be unfolded better even if a small amount of tension is applied during the folding.

Therefore, the pouch bridge part 140 of the secondary battery pouch 130 manufactured by the secondary battery pouch forming apparatus 100 according to Aspect 1 of the present disclosure may be unfolded significantly better when the pouch is folded. In this case, the pouch bridge part 140 may move further in an outward direction E than that illustrated in FIG. 1 and then be unfolded straightly. In that case, an interference with the electrode assembly may not occur, and thus, the electrode assembly may be prevented from being damaged.

In addition to the preventing of the damage of the electrode assembly and thus the preventing of the damage of the cell, the apparatus for molding the secondary battery pouch according to Aspect 1 of the present disclosure may achieve effects of improving cell positioning precision and preventing wrinkles on a cell sealing area.

When the pouch bridge part 140 is unfolded well, the outer appearance of the cell may be precisely formed, and thus, a position may be precisely measured by a vision camera, etc. This may lead to improved positioning accuracy. In addition, if the pouch bridge part 140 is unfolded well, the problem of the wrinkles occurring when sealing the periphery of the pouch may be prevented due to the improved precision.

Thus, the apparatus for molding the secondary battery pouch and the secondary battery according to Aspect 1 of the present disclosure may implement a secondary battery having excellent quality.

### Aspect 2

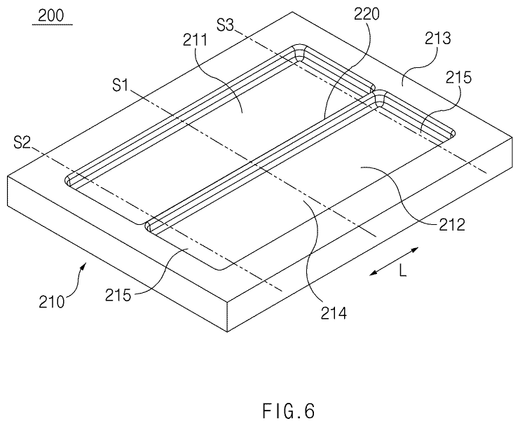

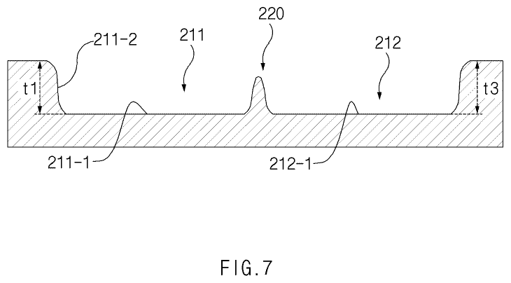

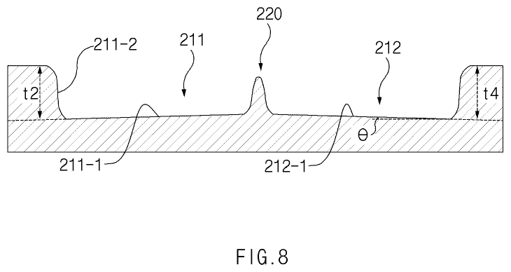

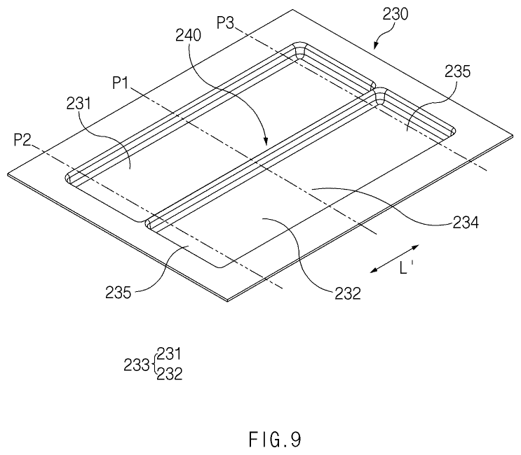

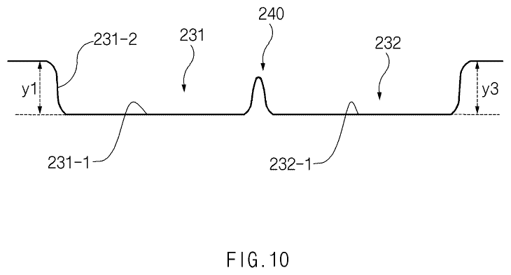

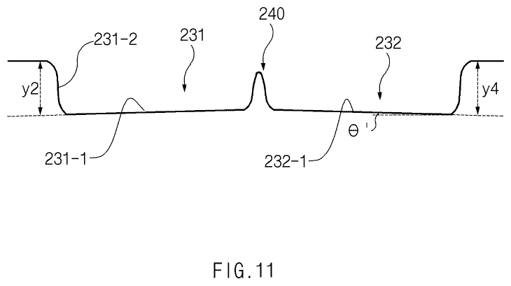

FIG. 6 is a perspective view illustrating a die of an apparatus for molding a secondary battery pouch according to Aspect 2 of the present disclosure. FIG. 7 is a cross-sectional view taken at a position S1 of FIG. 6. FIG. 8 is a cross-sectional view taken at positions S2 and S3 of FIG. 6. FIG. 9 is a perspective view illustrating the secondary battery pouch manufactured by the apparatus for molding the secondary battery pouch according to Aspect 2 of the present disclosure. FIG. 10 is a cross-sectional view taken at a position P1 of FIG. 9. FIG. 11 is a cross-sectional view taken at positions P2 and P3 of FIG. 9.

Aspect 2 of the present disclosure is different from Aspect 1 in that it is characterized in that a portion of a bottom surface of each of left and right receiving grooves of a die has an inclined shape.

The contents that are duplicated with Aspect 1 will be omitted as much as possible, and Aspect 2 will be described with a focus on the differences. That is, it is obvious that the contents that are not described in Aspect 2 may be regarded as the contents of Aspect 1 if necessary.

An apparatus 200 for molding a secondary battery pouch according to Aspect 2 of the present disclosure may include a die 210 and a punch.

The die 210 may be configured to have an accommodation groove for molding a cup part of the pouch on a base surface 213 on which the pouch is placed.

Specifically, the die 210 includes a left accommodation groove 211 having a recessed shape, a right accommodation groove 212 formed in a side portion of the left accommodation groove 211 and having an recessed shape, and a bridge part 220 connecting the left accommodation groove 211 to the right accommodation grooves 212 between the left accommodation groove 211 and the right accommodation groove 212.

The punch 150 may be configured to mold the cup part of the pouch while being inserted into the accommodation groove of the die 210. The punch may have a shape corresponding to the groove of the die 210, and the pouch may be molded by being inserted into the recessed groove of the die 210. The pouch molded in this manner may have the same shape as the secondary battery pouch 230 illustrated in FIGS. 9 to 11.

Referring to FIG. 6, in the apparatus 200 for molding the secondary battery pouch according to Aspect 2 of the present disclosure, bottom surfaces of the left accommodation groove 211 and the right accommodation groove 212 may be formed horizontally on a central area 214 and may be formed to be inclined on both end areas 215, based on a direction parallel to a longitudinal direction L of the bridge part 220.

FIG. 7 is a cross-sectional view taken at a position S1 of FIG. 6. A cross-sectional view cut at a position S1 may mean a cross-sectional view on the central area 214. As illustrated in the cross-sectional view of FIG. 7, a bottom surface of the accommodation groove on the central area 214 is not inclined, that is, is formed horizontally.

FIG. 8 is a cross-sectional view taken at positions S2 and S3 of FIG. 6. The cross-sectional view cut at positions S2 and S3 may mean a cross-sectional view on both the end areas 215. As illustrated in the cross-sectional view of FIG. 8, the bottom surfaces of the accommodation groove at each of both the end areas 215 may be inclined. In the apparatus 200 for molding the secondary battery pouch according to Aspect 2 of the present disclosure, cross-sections of the accommodation grooves at positions S2 and S3 may be the same, and the cross-sectional view may be the cross-sectional view illustrated in FIG. 8.

Referring to FIG. 8, in both the end areas 215, a bottom surface 211-1 of the left accommodation groove and a bottom surface 212-1 of the right accommodation groove may be formed to be inclined to increase in height as approaching the bridge part 220. Specifically, in both the end areas 215, an inclination angle θ formed by the bottom surface 211-1 of the left accommodation groove and the bottom surface 212-1 of the right accommodation groove with respect to a horizontal plane is 1 degree to 10 degrees.

In the apparatus 200 for molding the secondary battery pouch according to Aspect 2 of the present disclosure, each of the left accommodation groove 211 and the right accommodation groove 212 may include a bottom surface and a sidewall surface 211-2 extending upward from a circumference of the bottom surface. It is possible to implement a shape in which the bottom and sidewall surfaces are recessed together.

In addition, the sidewall surface 211-2 of the left accommodation groove 211 measured based on the bottom surface 211-1 of the left accommodation groove may have the same height at the central area 214 and both the end areas 215. This is explained in detail as follows.

First, referring to FIG. 7, a height of the sidewall surface 211-2 of the left accommodation groove 211 measured based on the bottom surface 211-1 of the left accommodation groove on the central area 214 may be t1. In addition, referring to FIG. 8, a height of the sidewall surface 211-2 of the left accommodation groove 211 measured based on the bottom surface 211-1 of the left accommodation groove on each of both the end areas 215 may be t2. Here, t1 and t2 may have the same value (t1=t2).

In addition, in the apparatus 200 for molding the secondary battery pouch according to Aspect 2 of the present disclosure, the sidewall surface 211-2 of the right accommodation groove 212 measured based on the bottom surface 212-1 of the right accommodation groove may have the same height at the central area and both the end areas 215. This is explained in detail as follows.

First, referring to FIG. 7, a height of the sidewall of the right accommodation groove 212 measured based on the bottom surface 212-1 of the right accommodation groove on the central area 214 may be t3. In addition, referring to FIG. 8, a height of the sidewall of the right accommodation groove 212 measured based on the bottom surface 212-1 of the right accommodation groove on each of both the end areas 215 may be t4. Here, t3 and t4 may have the same value (t3=t4).

In addition, in the apparatus 200 for molding the secondary battery pouch according to Aspect 2 of the present disclosure, the left accommodation groove 211 and the right accommodation groove 212 may be formed in shapes that are symmetrical to each other with respect to the bridge part 220. Specifically, that are symmetrical with respect to the bridge part 220 means that the left accommodation groove 211 and the right accommodation groove 212 have a symmetrical shape based on a virtual plane that cuts the bridge part 220 perpendicularly.

In this case, t1=t3 and t2=t4. In addition, according to the previous explanation, t1=t2 and t3=t4, and as a result, t1=t2=t3=t4. That is, all of t1, t2, t3, and t4 may have the same value.

When the pouch is molded using the apparatus 200 for molding the secondary battery pouch described above, the secondary battery pouch 230 illustrated in FIGS. 9 toll may be manufactured.

Referring to FIG. 9, the secondary battery pouch 230 manufactured by the apparatus 200 for manufacturing the secondary battery pouch according to Aspect 2 of the present disclosure may include a pouch cup part 233 and a pouch bridge part 240.

Here, the pouch cup part 233 may include two cup parts such as a left cup part 231 and a right cup part 232. The pouch cup part 233 may be configured to be provided with two cup parts such as a left cup part 231 and a right cup part 232. The pouch bridge part 240 may be configured to connect the two cup parts to each other between the left cup part 231 and the right cup part 232.

A portion molded by a left accommodation groove 211 of the die 210 may be the left cup part 231, and a portion molded by the right accommodation groove 212 may be the right cup part 232. In addition, the portion formed by the bridge part 220 of the die 210 may be the pouch bridge part 240.

Referring to FIGS. 9 to 11, the left cup part 231 and the right cup part 232 may have horizontal bottom surfaces on the central area 234 based on the direction parallel to the longitudinal direction L′ of the pouch bridge part 240 and inclined bottom surfaces both the end areas 235. This may be a result of the shape of the pouch cup part 233 being formed to correspond to the shape of the accommodation groove of the die 210.

FIG. 10 is a cross-sectional view taken at a position PI of FIG. 9. A cross-sectional view cut at a position P1 may mean a cross-sectional view on the central area 234. As illustrated in the cross-sectional view of FIG. 10, a bottom surface of the accommodation groove on the central area 234 is not inclined, that is, is formed horizontally.

FIG. 11 is a cross-sectional view taken at positions P2 and P3 of FIG. 9. The cross-sectional view cut at the positions P2 and P3 may mean a cross-sectional view on both the end areas 235. As illustrated in the cross-sectional view of FIG. 11, the bottom surfaces of the accommodation groove at each of both the end areas 235 may be inclined. In the secondary battery pouch 230 manufactured by the apparatus 200 for molding the secondary battery pouch according to Aspect 2 of the present disclosure, cross-sections of the accommodation grooves at positions P2 and P3 may be the same, and the cross-sectional view may be the cross-sectional view illustrated in FIG. 11.

Referring to FIG. 11, in both the end areas 235, a bottom surface 231-1 of the left cup part 231 and a bottom surface 232-1 of the right cup part 232 may be formed to be inclined to increase in height as approaching the pouch bridge part 240. Specifically, in both the end areas 235, an inclination angle θ formed by the bottom surface 231-1 of the left cu part 231 and the bottom surface 232-1 of the right cup part 232 with respect to a horizontal plane is 1 degree to 10 degrees.

In the secondary battery pouch 230 manufactured by the apparatus 200 for molding the secondary battery pouch according to Aspect 2 of the present disclosure, each of the left cup part 231 and the right cup part 232 may include a bottom surface and a sidewall surface 231-2 extending upward from a circumference of the bottom surface. It is possible to implement a shape in which the bottom and sidewall surfaces are recessed together.

In addition, the sidewall surface 231-2 of the left cup part 231 measured based on the bottom surface 231-1 of the left cup part 231 may have the same height at the central area 234 and both the end areas 235. This is explained in detail as follows.

First, referring to FIG. 10, a height of the sidewall surface 231-2 of the left cup part 231 measured based on the bottom surface 231-1 of the left cup part 231 on the central area 234 may be y1. In addition, referring to FIG. 11, a height of the sidewall surface 231-2 of the left cu part 231 measured based on the bottom surface 231-1 of the left cup part 231 on each of both the end areas 235 may be y2. Here, y1 and y2 may have the same value (y1=y2).

In addition, in the secondary battery pouch 230 manufactured by the apparatus 200 for molding the secondary battery pouch according to Aspect 2 of the present disclosure, the sidewall surface of the right cup part 232 measured based on the bottom surface 232-1 of the right cup part 232 may have the same height at the central area 234 and both the end areas 235. This is explained in detail as follows.

First, referring to FIG. 10, a height of the sidewall of the right cup part 232 measured based on the bottom surface 232-1 of the right cup part 232 on the central area 234 may be y3. In addition, referring to FIG. 11, a height of the sidewall of the right cup part 232 measured based on the bottom surface 232-1 of the right cup part 232 on each of both the end areas 235 may be t4. Here, y3 and y4 may have the same value (y3=y4).

In addition, in the secondary battery pouch 230 manufactured by the apparatus 200 for molding the secondary battery pouch according to Aspect 2 of the present disclosure, the left cup part 231 and the right cup part 232 may be formed in shapes that are symmetrical to each other with respect to the pouch bridge part 240. Specifically, that are symmetrical with respect to the pouch bridge part 240 means that the left cup part 231 and the right cup part 232 have a symmetrical shape based on a virtual plane that cuts the pouch bridge part 240 perpendicularly.

In this case, y1=y3 and y2=y4. In addition, according to what was explained earlier, y1=y2 and y3=y4, and as a result, y1=y2=y3=y4. That is, all of y1, y2, y3, and y4 may have the same value.

As manufactured by the secondary battery pouch molding apparatus 200 according to Aspect 2 of the present disclosure, in the secondary battery pouch 230 of the present disclosure, each of the left cup part 231 and the right cup part 232 may have a horizontal bottom surfaces on the central area 234 and inclined bottom surfaces on both the end areas 235. Thus, when the pouch is folded, the pouch bridge part 240 may be unfolded significantly better.

Since the secondary battery pouch 230 of the present disclosure has the inclined bottom surface on each of both the end areas 235, when folding the pouch in half so that an edge of the left cup part 231 and an edge of the right cup part 232 meet each other, a portion of the bottom surface of each of both the end areas 235 moves more. As a result, an edge portion of each of both the end areas 235 may pull the central area 234 of the pouch more. As a result, the pouch bridge part 240 may be unfolded significantly better on the central area 234.

When the pouch bridge part 240 is unfolded significantly better, the pouch bridge part 240 may move further in an outward direction E than that illustrated in, FIG. 1 and then be unfolded straightly. In that case, an interference with the electrode assembly may not occur, and thus, the electrode assembly may be prevented from being damaged.

In addition to the preventing of the damage of the electrode assembly and thus the preventing of the damage of the cell, the apparatus 200 for molding the secondary battery pouch according to Aspect 2 of the present disclosure may achieve effects of improving cell positioning precision and preventing wrinkles on a cell sealing area.

When the pouch bridge part 240 is unfolded well, the outer appearance of the cell may be precisely formed, and thus, a position may be precisely measured by a vision camera, etc. This may lead to improved positioning accuracy. In addition, if the pouch bridge part 240 is unfolded well, the problem of the wrinkles occurring when sealing the periphery of the pouch may be prevented due to the improved precision.

Thus, the apparatus 200 for molding the secondary battery pouch and the secondary battery according to Aspect 2 of the present disclosure may implement a secondary battery having excellent quality.

### Aspect 3

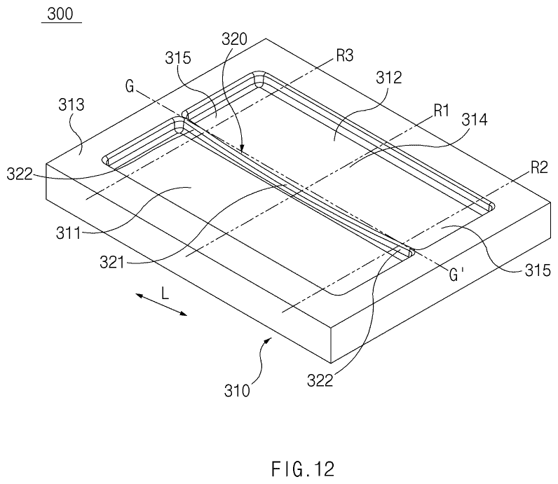

FIG. 12 is a perspective view illustrating a die of an apparatus for molding a secondary battery pouch according to Aspect 3 of the present disclosure.

Aspect 3 of the present disclosure is different from Aspects 1 and 2 in that the apparatus for molding the secondary battery pouch has the features of Aspect 1 and Aspect 2 described above, and the secondary battery pouch is manufactured therethrough.

The contents that are duplicated with Aspects 1 and 2 will be omitted as much as possible, and Aspect 2 will be described with a focus on the differences. That is, it is obvious that the contents that are not described in Aspect 3 may be regarded as the contents of Aspects 1 and 2 if necessary.

An apparatus 300 for molding a secondary battery pouch according to Aspect 3 of the present disclosure may include a die 310 and a punch.

The die 310 may be configured to have an accommodation groove for molding a cup part of the pouch on a base surface 313 on which the pouch is placed.

Specifically, the die 310 includes a left accommodation groove 311 having a recessed shape, a right accommodation groove 312 formed in a side portion of the left accommodation groove 311 and having an recessed shape, and a bridge part 320 connecting the left accommodation groove 311 to the right accommodation grooves 312 between the left accommodation groove 311 and the right accommodation groove 312.

The punch 150 may be configured to mold the cup part of the pouch while being inserted into the accommodation groove of the die 310. The punch may have a shape corresponding to the groove of the die 310, and the pouch may be molded by being inserted into the recessed groove of the die 310.

Referring to FIG. 12, in the apparatus 300 for molding the secondary battery pouch according to Aspect 3 of the present disclosure, the bridge part 320 may have a recessed shape so that a height of a central portion 321 of the bridge part 120 is less than that of each of both ends 322 in a longitudinal direction L. Here, a height of the bridge part 320 may continuously decrease from both the ends 322 to the central portion 321.

A cross-section of the bridge part 320, which is taken along line G-G′ illustrated in FIG. 12, may have the same shape as illustrated in FIG. 3. Therefore, the content described based on FIG. 3 in the description of foregoing Aspect 1 may be equally applied to the apparatus 300 for molding the secondary battery pouch according to Aspect 3.

A cross-section of the bridge part 320 may be formed in the same shape as a portion or entire of a U-shaped or may be formed in the same shape as a portion or entire of a circular or oval shape. In addition, a height h1 of the central portion 321 of the bridge part 320 may be 9 mm to 10 mm, and a height h2 of each of both the ends 322 of the bridge part 320 may be 11 mm to 12 mm.

In addition, referring to FIG. 12, in the apparatus 300 for molding the secondary battery pouch according to Aspect 3 of the present disclosure, bottom surfaces of the left accommodation groove 311 and the right accommodation groove 312 may be formed horizontally on a central area 314 and may be formed to be inclined on both end areas 315, based on a direction parallel to a longitudinal direction L of the bridge part 320.

A cross-section of the bottom surface of the accommodation groove cut by R1 illustrated in FIG. 12 may be the same as that illustrated in FIG. 7, and a cross-section of the bottom surface of the accommodation groove cut by R2 and R3 may be the same shape as illustrated in FIG. 8. Therefore, the content explained based on FIGS. 7 and 8 in the description of Aspect 2 above can be equally applied to the secondary battery pouch forming device 300 according to Aspect 3.

In both the end areas 315, the bottom surfaces of the left accommodation groove 311 and the right accommodation groove 312 may be formed to be inclined so that a height increases as approaching the bridge part 320, and an inclination angle θ formed by the bottom surfaces of the left accommodation groove 311 and the right accommodation groove 312 with respect to a horizontal plane is 1 degree to 10 degrees.

Each of the left accommodation groove 311 and the right accommodation groove may include a bottom surface and a sidewall surface extending upward from a circumference of the bottom surface, and the sidewall surface of the left accommodation groove 311 measured based on the bottom surface of the left accommodation groove 311 may have the same height at the central area 314 and both the end areas 315.

In addition, the sidewall surface of the right accommodation groove 312 measured based on the bottom surface of the right accommodation groove 312 may have the same height at the central area 314 and both the end areas 315. In addition, the left accommodation groove 311 and the right accommodation groove 312 may be formed in shapes that are symmetrical to each other with respect to the bridge part 320.

The secondary battery pouch manufactured by the apparatus 300 for molding the secondary battery pouch according to Aspect 3 of the present disclosure may also have features of the secondary battery pouch manufactured in Aspect 1 and Aspect 2. The secondary battery pouch (not shown) manufactured by the apparatus 300 for manufacturing the secondary battery pouch according to Aspect 3 of the present disclosure may include a pouch cup part and a pouch bridge part.

In addition, the pouch bridge part may be formed in a recessed shape so that a height of a central portion is lower than a height of each of both ends based on a longitudinal direction, the bottom surfaces of the left cup part and the right cup part may be formed horizontally on the central area based on a direction parallel to the longitudinal direction of the pouch bridge part, and the bottom surface may be formed to be inclined at each of both the end areas.

In addition, since the secondary battery pouch manufactured by the apparatus 300 for molding the secondary battery pouch according to Aspect 3 of the present disclosure has the features of the secondary battery pouch manufactured in Aspect 1 and Aspect 2, the features of the secondary battery pouch described in Aspect 1 based on FIG. 5 and the features of the secondary battery pouch described in Aspect 2 based on FIGS. 9 to 11 may also be directly applied to the apparatus 300 for molding the secondary battery pouch according to Aspect 3.

Therefore, in the apparatus for molding the secondary battery pouch and the secondary battery pouch manufactured therethrough according to Aspect 3, when the pouch is folded, the pouch bridge part may be unfolded well to prevent the cell damage, improve the cell positioning precision, and prevent the wrinkles on the cell sealing part, thereby producing the secondary battery having the excellent quality.

While the aspects of the present disclosure have been described with reference to the specific aspects, it will be apparent to those skilled in the art that various changes and modifications may be made without departing from the spirit and scope of the disclosure as defined in the following claims.

1. An apparatus for molding a secondary battery pouch, the apparatus comprising:
a die having a base surface and accommodation grooves, the accommodation grooves-configured for molding a cup part of a pouch placed on the base surface; and
a punch configured to insert into the accommodation grooves of the die to mold the cup part of the pouch,
wherein the accommodation grooves include:
a left accommodation groove having a recessed shape;
a right accommodation groove next to the left accommodation groove and having a recessed shape; and
a bridge part between the left accommodation groove and the right accommodation groove and connecting the left accommodation groove to the right accommodation groove, the bridge part having two ends,
wherein the bridge part has a recessed shape so that a height of a central portion thereof is less than a height of each of both ends in a longitudinal direction.

2. The apparatus of claim 1, wherein the bridge part height continuously decreases in a direction from each of both the ends to the central portion.

3. The apparatus of claim 1, wherein a cross-section of the bridge part, along a plane that divides the left and right accommodation grooves while passing lengthwise through the bridge part, has a U-shape.

4. The apparatus of claim 1, wherein a cross-section of the bridge part, along plane that divides the left and right accommodation grooves while passing lengthwise through the bridge part, has a semi-circular or semi-oval shape.

5. The apparatus of claim 1, wherein the height of the central portion of the bridge part is from 9 mm to 10 mm, and the height of each end of the bridge part is from 11 mm to 12 mm.

6. The apparatus of claim 1, wherein the punch comprises a punch protrusion having a shape protruding to correspond to the recessed shape of the bridge part.

7. An apparatus for molding a secondary battery pouch, the apparatus comprising:
a die having a base surface and accommodation grooves, the, accommodation grooves configured for molding a cup part of a pouch placed on the base surface; and
a punch configured to insert into the accommodation grooves of the die to mold the cup part of the pouch,
wherein the accommodation grooves include:
a left accommodation groove having a recessed shape;
a right accommodation groove next to the left accommodation groove and having a recessed shape; and
a bridge part between the left accommodation groove and the right accommodation groove and connecting the left accommodation groove to the right accommodation groove,
wherein each of the left accommodation groove and the right accommodation groove has a horizontal bottom surface at a central area and an inclined bottom surfaces at end areas, based on a direction parallel to a longitudinal direction of the bridge part.

8. The apparatus of claim 7, wherein, at the end areas, the bottom surface of each of the left accommodation groove and the right accommodation groove is inclined towards the bridge part.

9. The apparatus of claim 7, wherein the inclined bottom surfaces have an inclination angle (θ) with respect to horizontal is of from 1 degree to 10 degrees.

10. The apparatus of claim 7, wherein each of the left accommodation groove and the right accommodation groove comprise a bottom surface and a sidewall surface that extends upward from a circumference of the bottom surface, and
the sidewall surface height of the left accommodation groove, measured from the bottom surface of the left accommodation groove, is the same at the central area and at the end areas.

11. The apparatus of claim 10, wherein the sidewall surface height of the right accommodation groove, measured from the bottom surface of the right accommodation groove, is the same at the central area and both the end areas.

12. The apparatus of claim 7, wherein the left accommodation groove and the right accommodation groove are symmetrical to each other with respect to the bridge part.

13. An apparatus for molding a secondary battery pouch, the apparatus comprising:
a die having a base surface and accommodation grooves, the accommodation grooves configured for molding a cup part of a pouch placed on the base surface; and
a punch inserted into the accommodation grooves of the die to mold the cup part of the pouch,
wherein the accommodation grooves include:
a left accommodation groove having a recessed shape;
a right accommodation groove defined next to the left accommodation groove and having a recessed shape; and
a bridge part between the left accommodation groove and the right accommodation groove and connecting the left accommodation groove to the right accommodation groove, the bridge part having two ends,
wherein the bridge part has a recessed shape so that a height of a central portion is less than a height of each of both ends in a longitudinal direction, and
each of the left accommodation groove and the right accommodation groove has a horizontal bottom surface at a central area and inclined bottom surfaces hat end areas, based on a direction parallel to a longitudinal direction of the bridge part.

14. A secondary battery pouch comprising:
a pouch cup part comprising two cup parts of a left cup part and a right cup part; and
a pouch bridge part configured to connect the two cup parts to each other between the left cup part to the right cup part, the pouch bridge part having two ends,
wherein the pouch bridge part has a recessed shape so that a height of a central portion is less than a height of each of both the ends in a longitudinal direction.

15. The secondary battery pouch of claim 14, wherein the height of the-central portion is from 2 mm to 4 mm, and the height of each of both the ends of the pouch bridge part is from 4 mm to 6 mm.

16. A secondary battery pouch comprising:
a pouch cup part comprising two cup parts of a left cup part and a right cup part; and
a pouch bridge part configured to connect the two cup parts to each other between the left cup part to the right cup part,
wherein each of the left cup part and the right cup part has a horizontal bottom surface at a central area and an inclined bottom surface at end areas, based on a direction parallel to a longitudinal direction of the bridge part.

17. A secondary battery pouch comprising:
a pouch cup part comprising two cup parts of a left cup part and a right cup part; and
a pouch bridge part configured to connect the two cup parts to each other between the left cup part to the right cup part, the pouch bridge part having two ends,
wherein the pouch bridge part has a recessed shape so that a height of a central portion is less than a height of each of both the ends in a longitudinal direction, and
each of the left cup part and the right cup part has a horizontal bottom surface at a central area and an inclined bottom surface at end areas, based on a direction parallel to a longitudinal direction of the bridge part.
